(19) United States
(12) Patent Application Publication
(10) Pub. No.: US 2018/0024669 A1
(43) Pub. Date: Jan. 25, 2018

(54) TOUCH PANEL

(71) Applicant: SHARP KABUSHIKI KAISHA, Sakai City, Osaka (JP)

(72) Inventors: MASASHI MAYUMI, Sakai City (JP); DAIJI KITAGAWA, Sakai City (JP); ATSUSHI OKADA, Sakai City (JP)

(21) Appl. No.: 15/550,010

(22) PCT Filed: Feb. 3, 2016
(86) PCT No.: PCT/JP2016/053231

§ 371 Date: Aug. 9, 2017

(30) Foreign Application Priority Data
Feb. 9, 2015 (JP) 2015-023262

(51) Int. Cl. G06F 3/044; G06F 3/041

(52) U.S. Cl. CPC G06F 3/044; G06F 3/0418

(57) ABSTRACT

In a touch panel in which lines connected to electrodes used for detecting a touched position are arranged in an area where a touched position can be detected, the accuracy of detection of a touched position is improved. The touch panel includes a substrate; a group of electrode pairs arrayed in a predetermined direction on the substrate; a terminal unit arranged closer to one of ends in the predetermined direction on the substrate, than the group of electrode pairs is; a group of lead-out lines arranged on the substrate, for electrically connecting the group of electrode pairs and the terminal unit; and a control unit electrically connected with the terminal unit, the control unit supplying a signal through the group of lead-out lines to the group of electrode pairs, and detecting an amount of change in charges from each electrode pair. The control unit includes a provisional decision part, and a correction part. The provisional decision part provisionally decides a touched position based on the amount of change in charges. The correction part, using a correction parameter set for an electrode pair at the provisionally decided touched position, corrects an amount of change in charges detected from the electrode pair arranged at a position farther from the terminal unit than the electrode pair at the provisionally decide touched position, in the group of electrode pairs.

### TECHNICAL FIELD

The present invention relates to a touch panel and more specifically, to a touch panel in which lead-out lines connected to electrodes used for detecting a touched position are arranged in an area in which a touched position can be detected.

### BACKGROUND ART

As an input device of an information apparatus such as smartphone or a tablet terminal, a touch panel is known widely. The touch panel is arranged, for example, so as to be stacked on a display screen of the information apparatus.

In recent years, it has been proposed to make narrower a part (a so-called frame region) surrounding the image display region in a display screen of an information apparatus. This is accompanied by a proposal of making a touched position detectable area wider also in a touch panel that is arranged so as to be stacked on a display screen of an information apparatus (see, for example, JP-A-2012-150782).

### PRIOR ART DOCUMENT

### Patent Document

Patent Document 1: JP-A-2012-150782

### SUMMARY OF THE INVENTION

### Problem to be Solved by the Invention

It is an object of the present invention to improve accuracy of detection of a touched position on a touch panel in which lead-out lines connected to electrodes used for detecting a touched position are arranged within a touched position detectable area.

### Means to Solve the Problem

A touch panel according to an embodiment of the present invention includes a substrate, a group of electrode pairs, a terminal unit, a group of lead-out lines, and a control unit. The electrode pairs in the group are arrayed in a predetermined direction on the substrate. The terminal unit is arranged closer to one of ends in the predetermined direction on the substrate, than the group of electrode pairs is. The group of lead-out lines is arranged on the substrate, for electrically connecting the group of electrode pairs and the terminal unit. The control unit, electrically connected with the terminal unit, supplies a signal through the group of lead-out lines to the group of electrode pairs, and detects an amount of change in charges from each electrode pair. The control unit includes a provisional decision part and a correction part. The provisional decision part provisionally decides a touched position based on the amount of change in charges. Using a correction parameter set for an electrode pair at the provisionally decided touched position, the correction part corrects an amount of change in charges detected from the electrode pair arranged at a position farther from the terminal unit than the electrode pair at the provisionally decide touched position, in the group of electrode pairs.

### Effect of the Invention

In the touch panel according to the embodiment of the present invention, the accuracy of detection of a touched position is improved.

### BRIEF DESCRIPTION OF DRAWINGS

FIG. 1 is a plan view illustrating a schematic configuration of a touch panel according to Embodiment 1 of the present invention.

FIG. 2 is a block diagram illustrating a schematic configuration of a controller that the touch panel illustrated in FIG. 1 includes.

FIG. 3 is an enlarged plan view illustrating three electrode pairs in the same column.

FIG. 4A is a graph showing noise.

FIG. 4B is a graph showing noise, the graph showing a case where a position farther from a pad than the position in the case of FIG. 4A is touched.

FIG. 5A is a flowchart showing a touched position deciding process performed by a central processing unit (CPU).

FIG. 5B is a flowchart showing a data correction process performed by CPU.

FIG. 6A is a graph showing changes in the amount of charges accumulated in an electrostatic capacitor that the electrode pair includes, the graph showing the amounts of changes in the charges after calibration.

FIG. 6B is a graph showing changes in the amount of charges accumulated in the electrostatic capacitor that the electrode pair includes, the graph showing the amounts of changes in the charges after correction.

FIG. 7A is a graph showing changes in the amount of charges accumulated in the electrostatic capacitor that the electrode pair includes, the graph showing the amounts of changes in the charges after calibration.

FIG. 7B is a graph showing changes in the amount of charges accumulated in the electrostatic capacitor that the electrode pair includes, the graph showing the amounts of changes in the charges after correction.

FIG. 8 is a flowchart illustrating a data correction process performed by a CPU in Embodiment 2 of the present invention.

### MODE FOR CARRYING OUT THE INVENTION

A touch panel according to are embodiment of the present invention includes a substrate, a group of electrode pairs, a terminal unit, a group of lead-out lines, and a control unit. The electrode pairs in the group are arrayed in a predetermined direction on the substrate. The terminal unit is arranged closer to one of ends in the predetermined direction on the substrate, than the group of electrode pairs is. The group of lead-out lines is arranged on the substrate, for electrically connecting the group of electrode pairs and the terminal unit. The control unit, electrically connected with the terminal unit, supplies a signal through the group of lead-out lines to the group of electrode pairs, and detects an amount of change in charges from each electrode pair. The control unit includes a provisional decision part and a correction part. The provisional decision part provisionally decides a touched position based on the amount of change in charges. Using a correction parameter set for an electrode pair at the provisionally decided touched position, the correction part corrects an amount of change in charges detected from the electrode pair arranged at a position farther from the terminal unit than the electrode pair at the provisionally decide touched position, in the group of electrode pairs.

On the touch panel, in the vicinity of the touched electrode pair, a lead-out line is present that is connected to an electrode pair arranged at a position farther from the terminal unit than the touched electrode pair. Capacitive coupling therefore occurs between the lead-out line and any electrode that composes the electrode pair. This capacitive coupling causes noise to be superposed on a result of detection at an electrode pair located at a position farther from the terminal unit than the touched electrode pair.

In the above-described touch panel, the results of detection at electrode located at positions farther from the terminal unit than the touched electrode pair are corrected. This therefore makes it possible to reduce defects caused by the coupling of noise superposed on the result of detection with noise from the outside (for example, noise from a display device used together with the touch panel), more specifically, to reduce adverse effects on the detection of a touched position. As a result, the accuracy of detection of a touched position is improved.

The correction parameter may be, for example, set based on an actually measured amount of change in the charges, or alternatively, calculated based on an actually measured amount of change in the charges.

Preferably, regarding the widths of the lead-out lines, the lead-out line connected with the electrode pair arranged at a position farther from the terminal unit has a greater width. In this case, delay hardly occurs to the transmission of signals.

Preferably, the correction parameters are set for the electrode pairs, respectively. An amount of correction by the correction parameter is greater with respect to the electrode pair connected to the lead-out line having a greater width.

If a lead-cut line has a greater width, greater capacitive coupling occurs. If greater capacitive coupling occurs, noise increases. In the above-described aspect, the amount of correction by a correction parameter set for an electrode pair connected with a lead-out line having a greater width is greater than the amount of correction by a correction parameter set for an electrode pair connected with a lead-out line having a smaller width. This therefore makes it possible to more appropriately correct a result of detection on which noise is superposed.

The correction parameters may be set for the electrode pairs, respectively. The correction parameters may include a correction parameter set for a combination of a plurality of the electrode pairs. An amount of correction by the correction parameter may be greater with respect to the electrode pair arranged at a position farther from the terminal unit.

Preferably, the control unit further includes a first determination part, a second determination part, and a revision part. The first determination part determines whether or not the amount of change in charges after correction by the correction part is negative. In a case where the amount of change in charges after correction by the correction part is negative, the second determination part determines whether or not the amount of change in charges before correction by the correction part is positive. In a case where the amount of change in charges before correction by the correction part is positive, the revision part revises the amount of change in the charges after correction by the correction part to zero.

In a case where a waterdrop adheres, the amount of change in the charges is negative at the position where the waterdrop adheres. In the above-described aspect, in a case where the amount of change in the charges before correction is positive and the amount of change in the charges after correction is negative, the amount of change in the charges after correction is revised to zero. This makes it possible to prevent it from being determined that a waterdrop would have adhered though no waterdrop actually adheres.

The following describes embodiments of the present invention in detail, while referring to the drawings. Identical or equivalent parts in the drawings are denoted by the same reference numerals, and the descriptions of the same are not repeated.

### Embodiment 1

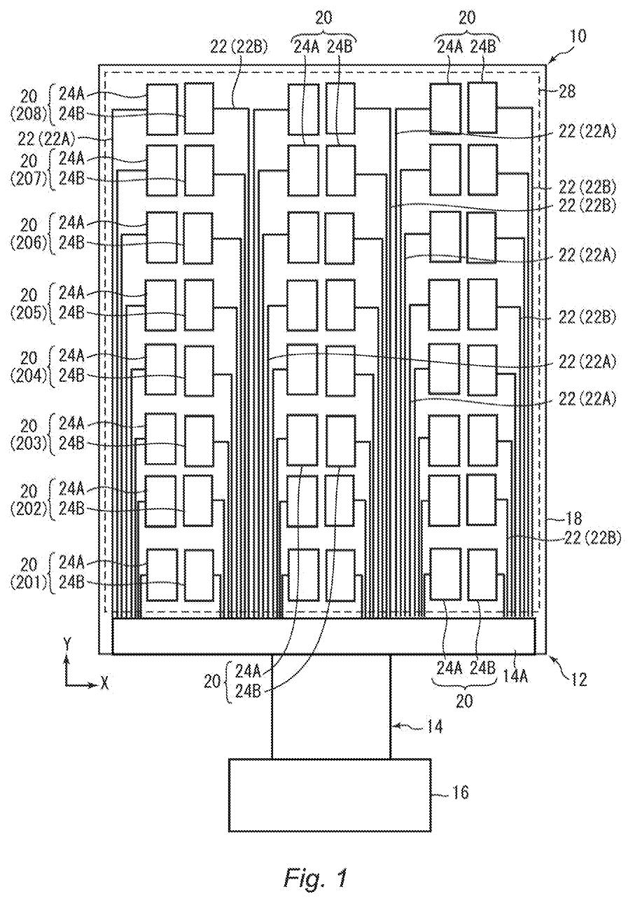

FIG. 1 is a plan view illustrating a schematic configuration of a touch panel 10 according to Embodiment 1 of the present invention. The touch panel 10 is arranged, for example, so as to be stacked on a display region that a display device has.

According to FIG. 1, the touch panel 10 includes a touch panel main body 12, flexible printed circuits (FPC) 14, and a controller 16. The touch panel main body 12 includes a substrate 18, a plurality of electrode pairs 20, and a plurality of lead-out line 22.

The substrate 18 is made of a material that allows visible light to pass therethrough. The substrate 18 is, for example, a glass substrate. In the example illustrated in FIG. 1, the substrate 18 has a rectangular shape.

The electrode pairs 20 are formed on the substrate 18, and are arranged in matrix. In the example illustrated in FIG. 1, one electrode pair group is formed with eight electrode pairs 201 to 208 arrayed in one column. In other words, in the present embodiment, three electrode pair groups are arranged. The electrode pair 20 includes a drive electrode 24A, and a sense electrode 24B.

The sense electrode 24B is arranged adjacent to the drive electrode 24A in the X direction (row direction). The sense electrode 24B is arranged at the same position in the Y direction (column direction) as the drive electrode 24A. The drive electrode 24A and the sense electrode 24B are formed in the same layer.

The drive electrodes 24A and the sense electrodes 24B are identical in size and shape. In the example illustrated in FIG. 1, the drive electrode 24A and the sense electrode 24B have a rectangular shape.

In two of the electrode pairs 20 that are adjacent in the Y direction, the drive electrodes 24A and the sense electrodes 24B are arranged at the same positions in the X direction, respectively. In the two of the electrode pairs 20 adjacent in the X direction, the drive electrodes 24A and the sense electrodes 24B are alternately arranged.

The drive electrodes 24A and the sense electrodes 24B are formed with transparent conductive films. The transparent conductive films are, for example, indium tin oxide films.

A plurality of lead-out lines 22 are electrically connected to the plurality of electrode pairs 20, respectively. The lead-out lines 22 may be formed in the same layer as the drive electrodes 24A and the sense electrodes 24B, or may be formed in a layer different from the layer where the drive electrodes 24A and the sense electrodes 24B are formed. Incidentally, in the present embodiment, the lead-out lines 22 are formed in the same layer as the layer where the drive electrodes 24A and the sense electrodes 24B are formed. The lead-out lines 22 may be made of the same material as that for the drive electrode 24A and the sense electrode 24B, or may be formed with a material different from that for the drive electrodes 24A and the sense electrodes 24B. For example, in a case where the lead-out lines 22 are arranged at positions that overlap the black matrix formed in the display region, the lead-out lines 22 may be formed with metal films.

The lead-out lines 22 include lead-out lines 22A connected to the drive electrode 24A, and lead-out lines 22B connected to the sense electrodes 24B. The lead-out line 22A has a portion that extends in the Y direction. At an end of the lead-out line 22A, a terminal connected to the FPC 14 is formed. The lead-out line 22B has a portion that extends in the Y direction. At an end of the lead-out line 22B, a terminal connected to the FPC 14 is formed. The terminals of the lead-out lines 22A, 22B gather in the vicinity of one of a pair of sides positioned away in the Y direction, among the four sides of the substrate 18 (the lower side in FIG. 1).

The plurality of lead-out lines 22 are arranged in an area 28 in the touch panel 10 where a touched position can be detected. The area 28 overlaps the display region that the display device has when the touch panel main body 12 is arranged so as to be stacked on the display device that is used together with the touch panel 10.

The FPC 14 connects the touch panel main body 12 and the controller 16 to each other. The FPC 14 includes a pad 14A as a terminal unit. The pad 14A is electrically connected to terminals of the lead-out lines 22A, 22B.

The controller 16 are electrically connected to the lead-out lines 22 through the FPC 14. The controller 16 supplies signals to each of the electrode pairs 20 through the lead-out lines 22. The controller 16 decides coordinates of a touched position based on changes in the signals supplied to the electrode pairs 20. The changes in the signals are caused by changes in electrostatic capacitors that the electrode pairs 20 have; in other words, the changes in the signals are caused by changes in electrostatic capacitors formed between the drive electrodes 24A and the sense electrodes 24B.

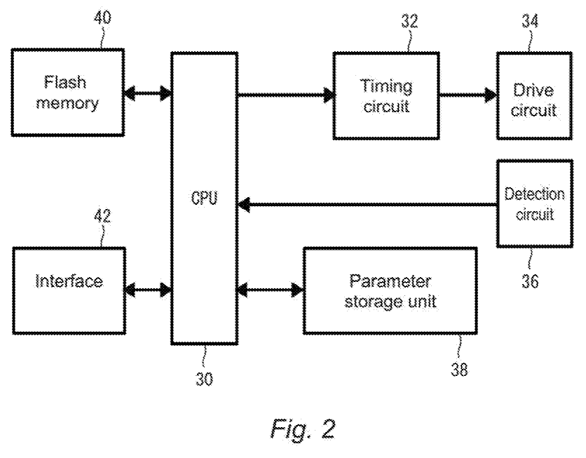

The following describes the controller 16 while referring to FIG. 2. The controller 16 includes a CPU 30, a timing circuit 32, a drive circuit 34, a detection circuit 36, a parameter storage unit 38, a flash memory 40, and an interface 42.

The CPU 30 controls operations of the touch panel main body 12. The CPU 30 reads a program stored in the flash memory 40, and based on this program, the CPU 30 executes venous types of processing operations.

The timing circuit 32 outputs a timing signal to the drive circuit 34. The timing signal is output at a predetermined period.

The drive circuit 34 outputs a signal based on the timing signal output by the timing circuit 32. The signal is output at a predetermined period.

When the drive circuit 34 outputs the signal, an electric field is generated between the drive electrode 24A and the sense electrode 24B. As a result, charges are accumulated in the electrostatic capacitor formed between the drive electrode 24A and the sense electrode 24B. In a case where a certain area in the area 28 is touched, the amount of charges accumulated in the electrostatic capacitor that the electrode pair 20 in the vicinity of the touched area has (the electrostatic capacitor formed between the drive electrode 24A and the sense electrode 24B).

The detection circuit 36 detects the amount of such a change in the charges. The detection circuit 36 includes, for example, an A/D conversion circuit.

The parameter storage unit 38 stores calibration parameters and correction parameters.

In the present embodiment, the calibration parameter is used for making the amount of the change in the charges detected by the detection circuit 36 within such a range that the amount of the change can be treated in subsequent processing operations.

The correction parameter is used for correcting the calibrated amount of the amount of change in the charges, and indicates the correction amount to be subtracted from the calibrated amount of change in the charges. The correction parameters are set for the electrode pairs 20, respectively. Details of the correction parameters are to be described in conjunction with a data correction processing operation executed by the CPU 30 to be described below.

The interface 42 connects the display device used together with the touch panel 10, and the controller 16 with each other.

In the touch panel 10, in a case where any area in the area 28 illustrated in FIG. 1 is touched, as described above, the amount of charges accumulated in an electrostatic capacitor formed between the drive electrode 24A and the sense electrode 24B changes. Based on such an amount of change in the charges, coordinates of the touched position are detected.

Here, the line length of the lead-out line connected to the electrode pair increases the electrode pair is farther from the pad. If, therefore, all the lead-out lines have the same line width, there is a risk that delay would occur to signal transmission to the electrode pair farther from the pad. It is therefore preferable that the lead-out line 22 connected to the electrode pair 20 arranged at a position farther from the pad 14A has a greater line width.

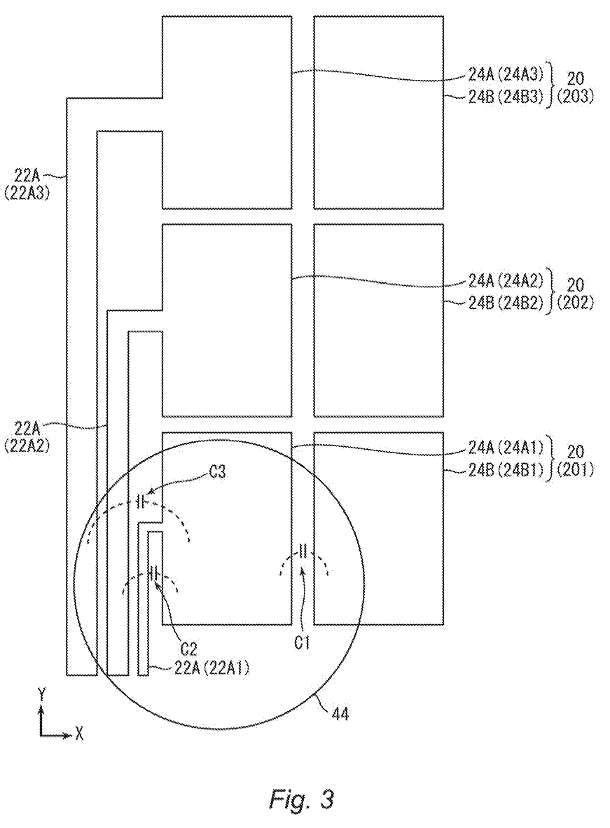

FIG. 3 is a schematic enlarged diagram illustrating a case where the electrode pair 201 is touched in the touch panel 10. In FIG. 3, only the electrode pairs 201, 202, and 203 are illustrated. As illustrated in FIG. 3, the lead-out line 22A3 connected to the drive electrode 24A3 that the electrode pair 203 includes has a greater line width than the line width of the lead-out line 22A2 connected to the drive electrode 24A2 that the electrode pair 202 includes. The lead-out line 22A has a greater line width than the line width of the lead-out line 22A1 connected to the drive electrode 24A1 that the electrode pair 201 includes.

The touched area 44 surrounded with a circle in FIG. 3 is an area touched by, for example, a human's finger or the like. In the example illustrated in FIG. 3, the touch area 44 overlaps the electrode pair 201. In this case, the capacitance of the electrostatic capacitor C1 that the electrode pair 201 has changes. This leads to a change in the amount of charges accumulated in the electrostatic capacitor C1. As a result, the position of the electrode pair 201 is detected as coordinates of the touched position.

In the example illustrated in FIG. 3, the lead-out line 22A2 and the lead-out line 22A3 are arranged in the vicinity of the drive electrode 24A1. The touch area 44 therefore overlaps the lead-out line 22A2 and lead-out line 22A3 as well. Here, capacitive coupling C2 occurs between the drive electrode 24A1 and the lead-out line 22A2, and capacitive coupling C3 occurs between the drive electrode 24A1 and the lead-out line 22A3. Influenced by the capacitive coupling C2 and C3, the amounts of charges accumulated in the electrostatic capacitors that the electrode pairs 202 and 203 have change. As a result, noise is superposed on the results of detection at the electrode pairs 202, 203.

In other words, noise is superposed on the results of detection at the electrode pairs 20 located at positions farther from the pad 14A (see FIG. 1) in the Y direction than the position of the electrode pair 20 of the touched position. For example, in FIG. 1, in a case where the electrode pair 201 is touched, noise is superposed on the results of detection at the electrode pairs 202 to 208. In a case where the electrode pair 205 is touched, noise is superposed on the results of the detection at the electrode pairs 206 to 208.

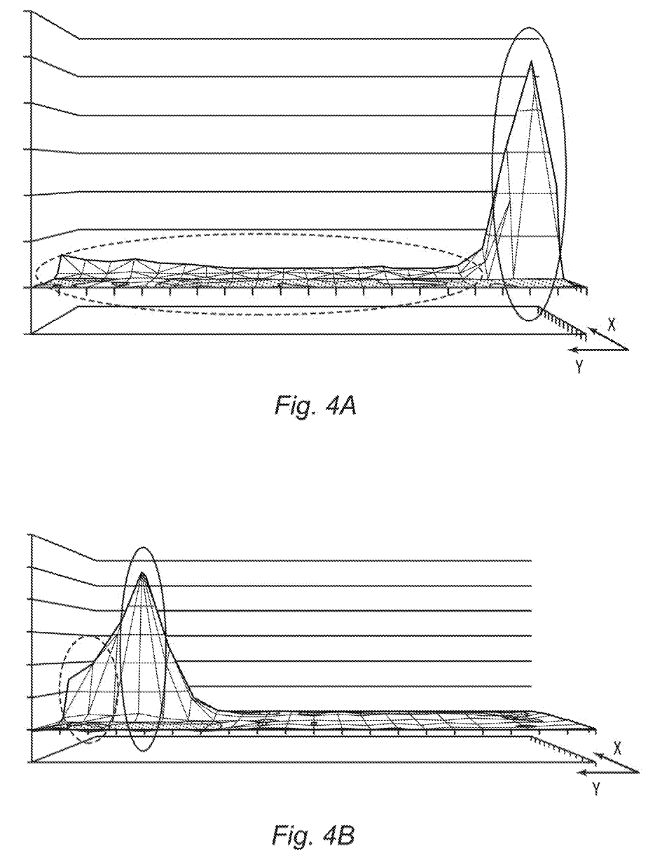

When a part of the area 28 illustrated in FIG. 1 is touched, the amount of charges accumulated in the electrostatic capacitor that the electrode pair (see FIG. 1) has changes, as illustrated in FIGS. 4A and 4B. In FIGS. 4A and 4B, the coordinate on the X axis and the coordinate on the Y axis indicate the position of the electrode pair 20, and the coordinate on the Z axis indicates the amount of charges accumulated in the electrostatic capacitor that the electrode pair 20 has. In FIGS. 4A and 4B, each of the parts surrounded by the solid lines indicates an amount of change in the charges at the touched area. In FIGS. 4A and 4B, each of the parts surrounded by the broken lines indicates noise.

Here the noise indicated in FIG. 4 greater than the noise indicated in FIG. 4A. The reason for this is as described below.

As illustrated in FIG. 3, the lead-out line 22A is wider as the drive electrode 24A connected to the lead-out line 22A is farther from the pad 14A. As the line width increases, the capacitive coupling increases. As the capacitive coupling increases, noise is greater. Here, in the case illustrated in FIG. 4B, an area farther from the pad 14A is touched, as compared with the case of FIG. 4A. The noise indicated in FIG. 4B, therefore, is greater the noise indicated in FIG. 4A.

As illustrated in FIGS. 4A and 4B, the result of detection at the electrode pair 20 thus touched (the amount of change in the charges) is much greater than noise. Even if, therefore, noise is superposed on the detection result, coordinates of the touched position can be detected. As known well, however, a touch panel is vulnerable to noise from outside. Noise from outside is, for example, noise from a display device used together with the touch panel. In a case where noise superposed on the detection result is coupled with noise from outside, there is a risk that it adversely affects the detection of coordinates of the touched position. In the touch panel, therefore, it is preferable to reduce noise superposed on the detection result, at a initial stage.

In the case of the touch panel 10, noise superposed on the detection result can be reduced. The following explains this point in detail.

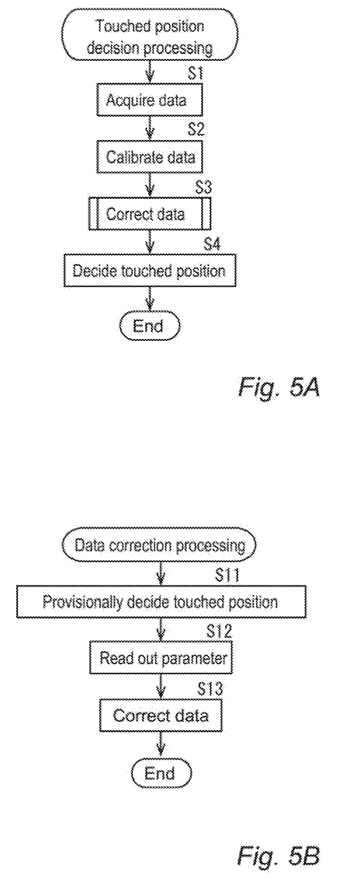

The CPU 30 performs a predetermined processing operation, in deciding coordinates of a touched position. The following describes the processing operation performed by the CPU 30, while referring to FIGS. 5A and 5B.

As illustrated in FIG. 5A, the CPU 30 acquires data at step S1. The data are the amounts of changes in the charges accumulated in the electrostatic capacitors that the electrode pairs 20 include. In other words, the data are the amounts of changes in the charges detected by the detection circuit 36.

Subsequently, at step S2, the CPU 30 calibrates the data acquired at step S1. More specifically, first, the CPU 30 reads out a calibration parameter from the parameter storage unit 38. Subsequently, the CPU 30 calibrates the data acquired at step S1, using the calibration parameter thus read out.

Subsequently, at step S3, the CPU 30 corrects the data thus calibrated at step S2. The following describes the data correcting operation at step S3, which is illustrated in FIG. 5A, while referring to FIG. 5B.

First, at step S11, the CPU 30 provisionally decides the electrode pair 20 at the touched position (touched electrode pair 20). As described above, the result of the detection at the touched electrode pair 20 (the amount of change in the charges) is considerably great, as compared with the noise superposed on the detection result. Such relationship is maintained even after the data calibration operation performed at step S2. For example, among all of the electrode pairs 20, an electrode pair 20 exhibiting an amount of change in the charges that is greater than a predetermined threshold value is provisionally decided as the touched electrode pair 20. One electrode pair 20 may be provisionally decided, or alternatively, a plurality of electrode pairs 20 may be provisionally decided.

Subsequently, at step S12, the CPU 30 reads out a correction parameter set for the electrode pair 20 provisionally decided at step S11, from the parameter storage unit 38.

For example, in the case of FIG. 1, the correction parameter to be read out in a where the electrode pair 201 is provisionally decided as the touched electrode pair 20 is used for reducing noise superposed on the detection results at the electrode pairs 202 to 208. As another example, a correction parameter to be read out in a case where the electrode pair 20 thus provisionally decided is the electrode pair 205 is a correction parameter used for reducing noise superposed on the detection results at the electrode pairs 206 to 208. The amount of correction by the correction parameter may be identical, irrespective of the electrode pairs 20, or alternatively, may vary depending on the electrode pair 20.

Here, as illustrated in FIGS. 4A and 4B, in a case where the touched area is far from the pad 14A (see FIG. 1), the noise increases. The amount of correction by the correction parameter set for the electrode pair 205, therefore, is preferably greater than the amount of correction by the correction parameter set for the electrode pair 201.

As illustrated in FIG. 1, the electrode pairs 201 to 208, which compose one electrode pair group, are arranged in one column. For example, in a case where two electrode pairs 201, 205 arranged in the same column are touched, noise is superposed on the results of detection at the electrode pairs 202 to 208. Here, the noise superposed on the results of detection at the electrode pairs 206 to 208 is greater than that in a case where the electrode pair 205 is touched. The reason is that not only the noise in the case where the electrode pair 205 is touched, but also the noise in the case where the electrode pair 201 is touched, is superposed.

In the above-described case, the correction parameters read out of the parameter storage unit 38 are the correction parameter set for the electrode pair 201, and the correction parameter set for the electrode pair 205. Alternatively, the correction parameter read out of the parameter storage unit 38 may be a correction parameter set for the combination of the two electrode pairs 201, 205. In the correction parameter set for the combination of the two electrode pairs 201, 205, the amount of correction for the results of detection at the electrode pairs 206 to 208 is greater than the amount of correction for the results of detection at the electrode pairs 202 to 204.

Incidentally, in FIG. 1, in a case where the electrode pair 208 is touched, no electrode pair 20 is present at a position farther from the pad 14A than the position of the electrode pair 208. In this case, therefore, the amount of correction by the correction parameter is set to zero.

Subsequently, at step S13, the CPU 30 corrects the data calibrated at step S2, by using the correction parameter read at step S12. More specifically the CPU 30 subtracts the amount of correction indicated by the correction parameter, from the amount of change in the charges after calibration. This makes it possible to correct the results of detection at the electrode pairs 20. As a result, this makes it possible to reduce noise.

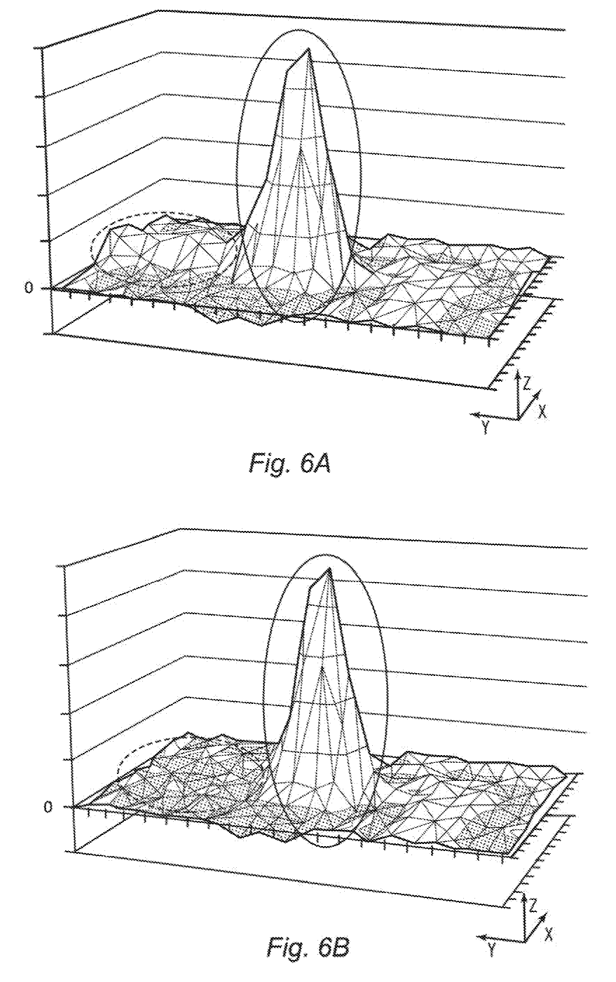

FIG. 6A illustrates a case where there is one touched electrode pair 20. FIG. 6A illustrates amounts of changes in the charges after calibration and before correction. In FIG. 6A, the coordinates on the X axis and the axis indicate the position of the electrode pair 20. In FIG. 6A, the coordinate on the Z axis indicates the amount of change in the charges. In FIG. 6A, the part surrounded by the solid line indicates the amount of change in the charges in the touched area. In FIG. 6A, the part surrounded by the broken line indicates the amount of change in the charges (containing noise) at an electrode pair 20 at a position farther from the pad 14A than the touched electrode pair 20. Data are corrected as described above, whereby the amount of change in the charges containing noise is corrected, as indicated by the part surrounded by the broken line in FIG. 6B. What are indicated by the X axis, the Y axis, and the Z axis in FIG. 6B are identical to what are indicated by the X axis, the Y axis, and the Z axis in FIG. 6A.

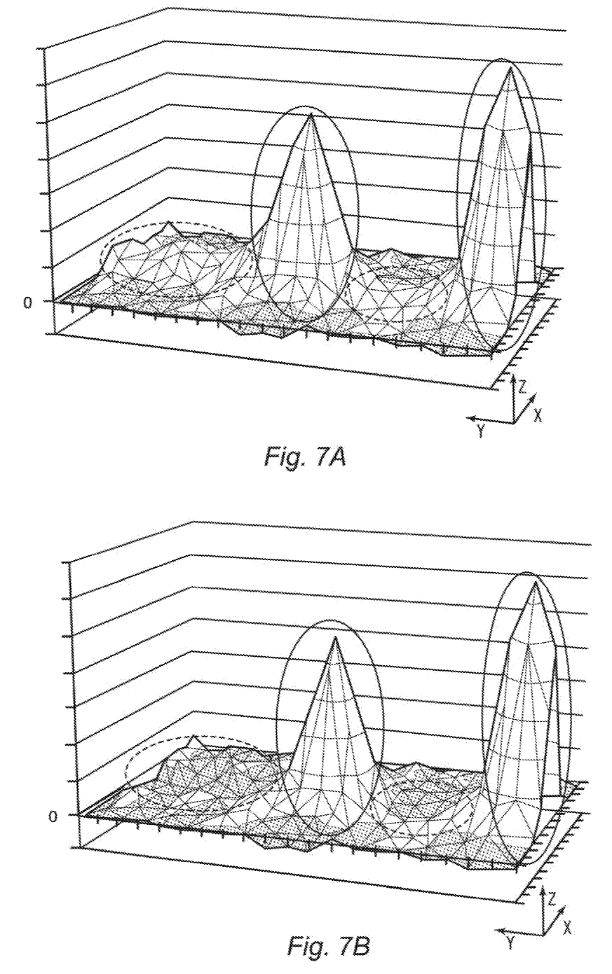

FIG. 7A illustrates a case where two electrode pairs 20 in the same column are touched. It should be noted that FIG. 7A illustrates the amounts of changes in the charges after calibration and before correction. In FIG. 7A, coordinates on the X axis and the Y axis indicate the position of the electrode pair 20. In FIG. 7A, the coordinate on the Z axis indicates the amount of change in the charges. In FIG. 7A, the part surrounded by the solid line indicates the amount of change in the charges in the touched area. In FIG. 7A, the part surrounded by the broken line indicates the amount of change in the charges (containing noise) at an electrode pair 20 at a position farther from the pad 14A than the touched electrode pair 20. Data are corrected as described above, whereby the amount of change in the charges containing noise is corrected, as indicated by the part surrounded by the broken line in FIG. 7B. What are indicated by the X axis, the Y axis, and the Z axis in FIG. 7B are identical to what are indicated by the X axis, the Y axis, and the Z axis in FIG. 7A.

After the amount of correction indicated by the correction parameter is subtracted from the amount of change in the charges after calibration as described above, the CPU 30 ends the data correction operation.

As illustrated in FIG. 5A, the CPU 30 decides the coordinates of the touched position at step S4. For example, the position of the electrode pair 20 having the amount of change in the charges after correction (the detection result after correction) greater than the predetermined threshold value is decided as the coordinates of the touched position. Thereafter, the CPU 30 ends the operation for deciding the touched position.

In the touch panel 10, a detection result on which noise is superposed is corrected at an initial stage. This therefore makes it possible to reduce defects caused by the coupling of noise superposed on the result of detection at the electrode pair 20 with noise from the outside, more specifically, to reduce adverse effects on the detection of coordinates of a touched position. As a result, the accuracy of detection of a touched position is improved.

### Embodiment 2

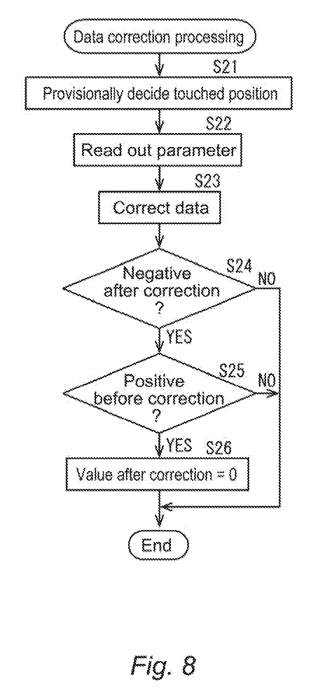

The following describes a touch panel according to Embodiment 2 of the present invention, while referring to FIG. 8. The present embodiment is different from Embodiment 1 regarding data correction processing.

As illustrated in FIG. 8, the CPU 30 provisionally decides an electrode pair 20 at the touched position at step S21. The processing operation at step S21 is identical to the processing operation at step 11 in Embodiment 1.

Subsequently, at step 22, the CPU 30 reads out, from the parameter storage unit 38, a correction parameter that is set for the electrode pair 20 at the touched position that is provisionally decided at step S21. The processing operation at step S22 is identical to the processing operation at step 12 in Embodiment 1.

Subsequently, at step S23, the CPU 30 corrects the data calibrated at step S2, by using the correction parameter that is read at step S22. The processing operation step S23 identical to the processing operation at step 13 in Embodiment 1.

Subsequently, at step S24, the CPU 30 determines whether or not the amount of change in the charges that is corrected at step S23 is negative. In a case where the amount of change in the charges after correction is positive (step S24; NO), the CPU 30 ends the data correction operation. In a case where the amount of change in the charges after correction is negative (step S24; YES), the CPU 30, at step S25, determines whether or not the amount of change in the charges before correction is positive.

In a case where the amount of change in the charges before correction is negative step S25: NO), the CPU 30 ends the data correction operation. In a case where the mount of change in the charges before correction is positive (step S25: YES), the CPU 30, at step S26, revises the amount of change in the charges corrected, at step S23, to zero. Thereafter, the CPU 30 ends the data correction operation.

In the present embodiment, even if the amount of change in the charges after correction is negative, if the amount of change in the charges before correction is positive, the amount of change in the charges after correction is revised to zero. Here, in a case where the amount of change in the charges is negative, it is considered that a waterdrop adheres at a position corresponding to the electrode pair 20 having an electrostatic capacitor where the amount of accumulated charges has changed. In a case where, therefore, the amount of change in the charges after correction is negative, there is a risk that it is determined that a waterdrop adheres at a position corresponding to the electrode pair 20 having an electrostatic capacitor where the amount of accumulated charges has changed. As described above, in the present embodiment, even if the amount of change in the charges after correction is negative, if the amount of change in the charges before correction is positive, the amount of change in the charges after correction is revised to zero. This makes it possible to prevent it from being determined that a waterdrop would have adhered though no waterdrop actually adheres.

Embodiments of the present invention are described above in detail, but these are merely examples. The present invention is not limited at all by the above-mentioned embodiments.

### DESCRIPTION OF REFERENCE NUMERALS

10: touch panel

16: controller

20: electrode pair

22: lead-out line

22A: lead-out line

22B: lead-out line

24A: drive electrode

24B: sense electrode

1. A touch panel comprising:
a substrate;
a group of electrode pairs arrayed in a predetermined direction on the substrate;
a terminal unit arranged closer to one of ends in the predetermined direction on the substrate, than the group of electrode pairs is;
a group of lead-out lines arranged on the substrate, for electrically connecting the group of electrode pairs and the terminal unit; and
a control unit electrically connected with the terminal unit, the control unit supplying a signal through the group of lead-out lines to the group of electrode pairs, and detecting an amount of change in charges from each electrode pair,
wherein the control unit includes:
a provisional decision part that provisionally decides a touched position based on the amount of change in charges; and
a correction part that, using a correction parameter set for an electrode pair at the provisionally decided touched position, corrects an amount of change in charges detected from the electrode pair arranged at a position farther from the terminal unit than the electrode pair at the provisionally decide touched position, in the group of electrode pairs.

2. The touch panel according to claim 1,
wherein, regarding the widths of the lead-out lines, the lead-out line connected with the electrode pair arranged at a position farther from the terminal unit has a greater width.

3. The touch panel according to claim 2,
wherein the correction parameters are set for the electrode pairs, respectively, and
an amount of correction by the correction parameter is greater with respect to the electrode pair connected to the lead-out line having a greater width.

4. The touch panel according to claim 1,
wherein the correction parameters are set for the electrode pairs, respectively.

5. The touch panel according to claim 4,
wherein an amount of correction by the correction parameter is greater with respect to the electrode pair arranged at a position farther from the terminal unit.

6. The touch panel according to claim 1,
wherein the correction parameters include a correction parameter set for a combination of a plurality of the electrode pairs.

7. The touch panel according to claim 1,
wherein the control unit further includes:
a first determination park that determines whether or not the amount of change in charges after correction by the correction part is negative,
a second determination part that, in a case where the amount of change in charges after correction by the correction part is negative, determines whether or not the amount of change in charges before correction by the correction part is positive, and
a revision part that, in a case where the amount of change in charges before correction by the correction part is positive, revises the amount of change in the charges after correction by the correction part to zero.
